(19) United States
(12) Patent Application Publication
(10) Pub. No.: US 2013/0278079 A1
(43) Pub. Date: Oct. 24, 2013

(54) ELECTRONIC DEVICE INCLUDING OVERHEATING PROTECTION DEVICE AND METHOD FOR USING THE SAME

(71) Applicants: KANG WU, Shenzhen (CN); WEI-DONG CONG, Shenzhen (CN)

(72) Inventors: KANG WU, Shenzhen (CN); WEI-DONG CONG, Shenzhen (CN)

(21) Appl. No.: 13/674,957

(22) Filed: Nov. 13, 2012

(30) Foreign Application Priority Data
Apr. 20, 2012 (CN) 201210117504.2

(51) Int. Cl. H01H 47/00

(52) U.S. Cl. CPC H01H 47/002
USPC 307/116

(57) ABSTRACT

An electronic device includes a main board and a heat dissipation device, and the heat dissipation device includes a plurality of fans and a micro control unit (MCU). The main board and the plurality of fans are electrically connected to the MCU. The MCU controls the plurality of fans to rotate, and each of the plurality of fans sends a feedback signal to the MCU as long as it is working normally. When a feedback signals from at least one of the plurality of fans in not received, the MCU applies a soft power-off to the main board after storing current data of the electronic device.

### BACKGROUND

1. Technical Field

The present disclosure relates to overheat protection devices of electronic devices, and particularly to an electronic device including an overheating protection device and a method for using the same.

2. Description of Related Art

Many electronic devices, such as personal computers, have heat dissipation devices. A heat dissipation device of an electronic device may include a plurality of fans or blowers to generate air flows and dissipate heat generated by the electronic device quickly. In use, a central processing unit (CPU) of the electronic device can control the plurality of fans or blowers to work synchronously. If the CPU senses that one or more of the fans or blowers malfunctions, the CPU can control the remaining fans or blowers to rotate at higher speeds and generate more air flows. Thus, the heat dissipation device can still quickly dissipate heat generated by the electronic device.

However, in such a heat dissipation device, if many of the plurality of fans or blowers malfunction, the remaining fans or blowers may be unable to provide adequate heat dissipation. In this condition, although the CPU controls each of the remaining fans or blowers to rotate at higher rotational speed, all air flows generated by the remaining fans or blowers may be incapable of dissipating heat generated in the electronic device in time, and a temperature in the electronic device may increase to dangerous levels.

Generally, the CPU of the electronic device stores an overheat protection temperature value. According to related art, if the temperature in the electronic device exceeds the overheat protection temperature value, the CPU immediately turns off the electronic device to protect the electronic device from overheating. However, when the electronic device is suddenly turned off because of overheating, a large amount of heat generated in the electronic device cannot be quickly dissipated, and may still cause overheating of the electronic device. Furthermore, suddenly turning off the electronic device may result in loss of data.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figure.

FIG. 1 is a block diagram of an electronic device, according to an exemplary embodiment.

FIG. 2 is a flowchart of a method for using the electronic device shown in FIG. 1, according to an exemplary embodiment.

### DETAILED DESCRIPTION

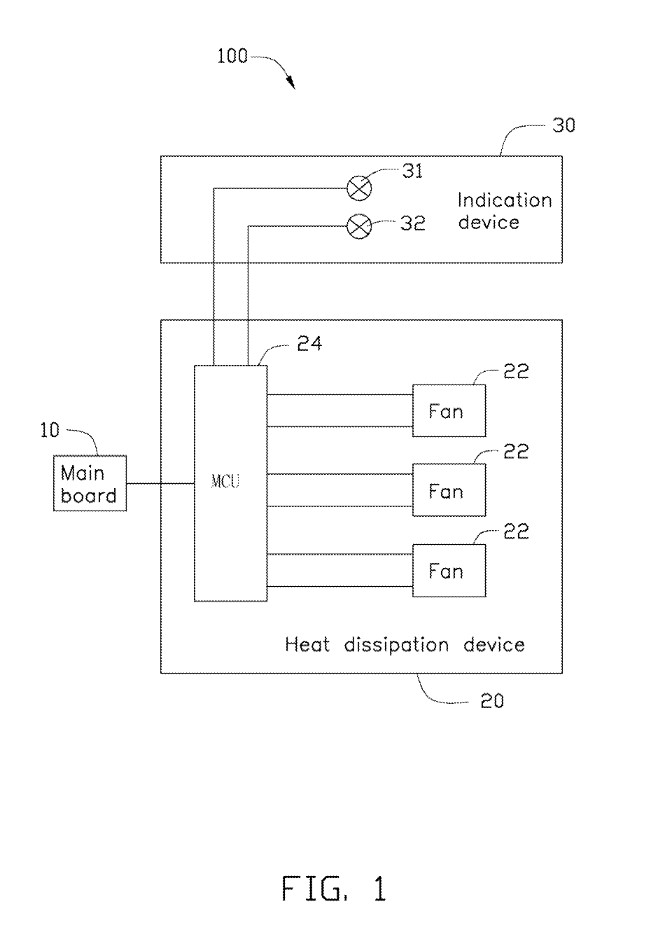

FIG. 1 is a block diagram of an electronic device 100, according to an exemplary embodiment. The electronic device 100 can be a personal computer (PC), a notebook computer, a computer server, for example. The electronic device 100 includes a main board 10, a heat dissipation device 20, and an indication device 30. The main board 10 can be any circuit board of the electronic device 100. When the main board 10 is working, the heat dissipation device 20 dissipates heat generated by the main board 10 to protect the main board 10 from overheating. The indication device 30 indicates a working status of the heat dissipation device 20.

The heat dissipation device 20 includes a plurality of fans 22 and a micro control unit (MCU) 24. The fans 22 are mounted on predetermined positions of the electronic device 100, and each of the fans 22 is electrically connected to the MCU 24. The MCU 24 can turn on or turn off each of the fans 22 individually, and can also adjust a rotation speed of each of the fans 22. When each of the fans 22 is working normally (i.e., rotating at an acceptable speed), the fan 22 generates a feedback signal (e.g., a voltage within a predetermined range) and sends the feedback signal to the MCU 24. The main board 10 is also electrically connected to the MCU 24. The MCU 24 sends a soft power-off instruction to the main board 10 to turn off the electronic device 100 softly (i.e., to turn off the electronic device 100 by performing predetermined programs stored in the electronic device 100, without cutting off the overall power supply to the electronic device 100 abruptly).

The indication device 30 includes a first indication lamp 31 and a second indication lamp 32 (e.g., light emitting diodes). Both the first indication lamp 31 and the second indication lamp 32 are electrically connected to the MCU 24, and the MCU 24 illuminates either the first indication lamp 31 or the second indication lamp 32 according to reception of feedback signals received from the plurality of fans 22. In this embodiment, when all of the plurality of fans 22 are working normally, each of the fans 22 sends a feedback signal to the MCU 24. When the MCU 24 receives the feedback signals from all of the plurality of fans 22, the MCU 24 illuminates the first indication lamp 31, to indicate that the heat dissipation device 20 is working normally. When at least one of the fans 22 malfunctions, the malfunctioning fan 22 does not send a feedback signal to the MCU 24. When the MCU 24 fails to receive a feedback signal from at least one (i.e., any one or more) of the fans 22, the MCU 24 illuminates the second indication lamp 32, to indicate that the heat dissipation device 20 may be malfunctioning.

When the MCU 24 fails to receive a feedback signal from at least one of the fans 22, the MCU 24 further sends a soft power-off instruction to the main board 10, to turn off the electronic device 100 softly. The immediate soft turning off of the electronic device 100, even when only one of the fans 22 malfunctions, means that heat already generated by the main board 10 inside the electronic device 100 is not excessive. Thus, the electronic device 100 can be protected from overheating. In this embodiment, since the electronic device 100 is softly turned off, data currently being processed by the main board 10 can be stored before the main board 10 stops working. Thus, the loss of data is prevented when the electronic device 100 is powered-off.

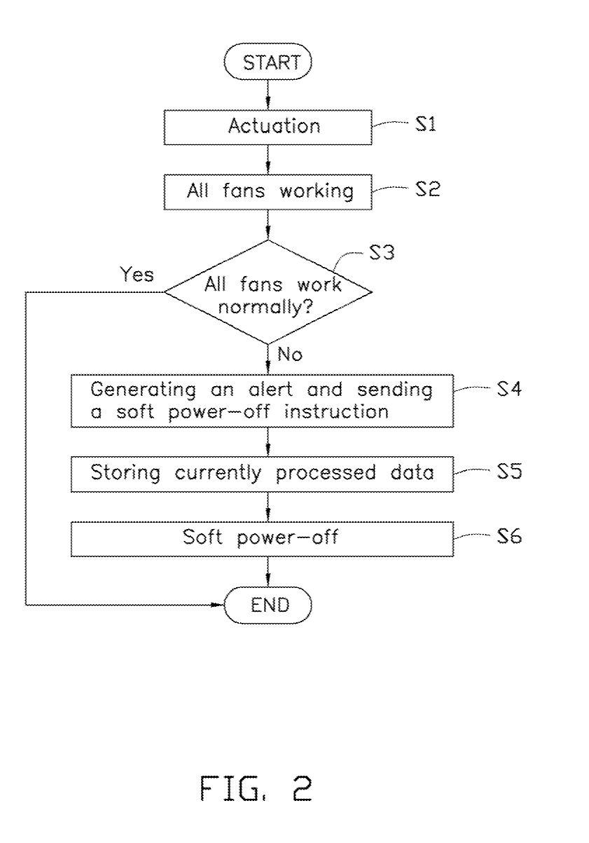

FIG. 2 is a flowchart of a method for using the electronic device 100, according to an exemplary embodiment. In this embodiment, the method includes following steps.

First, the electronic device 100 is actuated, and the main board 10 begins working as normal (Step S1).

When the MCU 24 is activated, the MCU 24 turns on all of the fans 22, to rotate at predetermined speeds. Thus, all of the fans 22 synchronously generate air flows in the electronic device 100 to dissipate heat generated by the main board 10 and other components (Step S2).

As long as each of the fans 22 is working normally, a feedback signal from the fan 22 is sent to the MCU 24. The MCU 24 detects the feedback signals received from each of the fans 22 to determine whether all of the fans 22 work normally or not (Step S3). If the MCU 24 is in fact receiving feedback signals from all of the fans 22, the MCU 24 determines that all of the fans 22 are working normally. The MCU 24 thus illuminates the first indication lamp 31, thereby indicating that the heat dissipation device 20 is working normally. As long as the MCU 24 receives feedback signals from all of the fans 22, the MCU 24 maintains the illumination of the first indication lamp 32.

If the MCU 24 fails to receive a feedback signal from at least one of the fans 22, the MCU 24 determines that one or more of the fans 22 is malfunctioning. The MCU 24 thus illuminates the second indication lamp 32, thereby giving a visible warning of a malfunction. At the same time, the MCU 24 sends a soft power-off instruction to the main board 10 (Step S4).

Upon reception of the soft power-off instruction, the main board 10 stores any data currently being processed (Step S5). When the data currently being processed has been stored, the main board 10 stops working, and the electronic device 100 is softly turned off (Step S6).

According to the above-described method, when the MCU 24 fails to receive a feedback signal from at least one of the fans 22, the MCU 24 almost immediately sends a soft power-off instruction to the main board 10 to turn off the electronic device 100 softly. Because the electronic device 100 is immediately turned off even if only one of the fans 22 malfunctions, the level of heat already generated by the main board 10 inside the electronic device 100 is not excessive. Thus, the electronic device 100 is protected from overheating. Furthermore, since the electronic device 100 is softly turned off, data currently being processed by the main board 10 is stored before the main board 10 stops working. The loss of data due to the power-off of the electronic device 100 is thus prevented.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An electronic device, comprising:
a main board; and
a heat dissipation device including a plurality of fans and a micro control unit (MCU), the main board and all of the plurality of fans electrically connected to the MCU;
wherein the MCU controls the plurality of fans to rotate; each of the plurality of fans sends a feedback signal to the MCU when each of the plurality of fans works normally; and in response to the MCU failing to receive the feedback signals from at least one of the plurality of fans, the MCU controls the main board to turn off.

2. The electronic device of claim 1, wherein the MCU controls the main board to turn off by sending a soft power-off instruction to the main board.

3. The electronic device of claim 2, wherein in response to the main board receiving the soft power-off instruction, the main board stores currently processed data of the electronic device, and stops working after storing the currently processed data of the electronic device.

4. The electronic device of claim 1, further comprising an indication device, wherein the indication device is electrically connected to the heat dissipation device to indicate a working status of the heat dissipation device.

5. The electronic device of claim 4, wherein the indication device includes a first indication lamp and a second indication lamp both electrically connected to the MCU, and wherein the MCU illuminates either the first indication lamp or the second indication lamp according to reception of the feedback signals from the plurality of fans.

6. The electronic device of claim 5, wherein when the MCU receives the feedback signals from each of the plurality of fans, the MCU illuminates the first indication lamp; and when the MCU fails to receive the feedback signal from at least one of the plurality of fans, the MCU illuminates the second indication lamp.

7. A method for using an electronic device including a plurality of fans configured for heat dissipation, comprising:
controlling the plurality of fans to rotate;
using each of the plurality of fans to generate a feedback signal when each of the plurality of fans works normally;
receiving the feedback signals from each of the plurality of fans; and
turning off the electronic device when the feedback signals are not received from at least one of the plurality of fans.

8. The method of claim 7, wherein turning off the electronic device includes sending a soft power-off instruction to a main board of the electronic device.

9. The method of claim 8, further comprising:
storing data currently processed by the main board once the main board receives the soft power-off instruction; and
softly turning off the electronic device after the main board stores the data.

10. The method of claim 7, further comprising:
illuminating a first indication lamp when the feedback signals are received from each of the plurality of fans.

11. The method of claim 9, further comprising:
illuminating a second indication lamp when the feedback signals are not received from at least one of the plurality of fans.
